(19) United States
(12) Patent Application Publication
(10) Pub. No.: US 2004/0105796 A1
(43) Pub. Date: Jun. 3, 2004

(54) Tank for epitaxy installation and installation comprising such a tank

(75) Inventors: Olivier Grange, Saint Cloud (FR); Pierre Bouchaib, Carrieres-Sur-Seine (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: Addon, a corporation of France, Carrieres-sur-Seine (FR)

(21) Appl. No.: 10/678,321

(22) Filed: Oct. 3, 2003

Related U.S. Application Data
(63) Continuation of application No. PCT/FR02/01180, filed on Apr. 4, 2002.

(30) Foreign Application Priority Data
Apr. 4, 2001 (FR) 01/04581

(51) Int. Cl. B01D 9/00

(52) U.S. Cl. 422/245.1

(57) ABSTRACT

A tank for producing arsenic vapor including a crucible located inside an exterior enclosure which isolates the crucible from the ambient atmosphere such that a space exists between the crucible and the exterior enclosure, the space being subjected to a pressure lower than atmospheric pressure, the crucible having an outlet duct and an input flange located at or adjacent a superheated portion of the crucible.

### RELATED APPLICATION

This is a continuation of International Application No. PCT/FR02/01180, with an international filing date of Apr. 4, 2002, which is based on French Patent Application No. 01/04581, filed Apr. 4, 2001.

### FIELD OF THE INVENTION

This invention relates to the field of epitaxy equipment.

### BACKGROUND

A method of deposition by sublimation of arsenic molecules for the formation of semiconductor components is known in the art. FR 2,679,929 describes an installation comprising a sublimation chamber for primary molecules which are transferred with a transfer flow into a cracking head at higher temperature to be transformed into lighter secondary molecules and form molecular jets. The transfer flow is regulated by regulation of a global vector flow which is that of a vector gas introduced into the sublimation chamber by a supply tube and aspirated by an aspiration tube.

EP 122,088 describes a source of molecular or atomic beams intended to be used in epitaxy by molecular jets, comprising a hollow crucible open at one end, and one or more crucible heating elements, characterized in that each element comprises an assembly of elongated, thin and practically parallel metal strips, arranged outside of the crucible at a certain distance from it, with the principal surfaces facing the crucible, these strips being connected electrically such that an electric current can pass through all of the strips.

The closest state of the art is constituted by a device described in U.S. Pat. No. 5,156,815. This device comprises an assembly constituted by a tank, a valve and an integral cracker element in which the vapor feed inlet of the valve is located opposite the load flange. FIG. 1 represents an implementation example in accordance with the prior art. The tank (1) reloadable by an assembly of internal and external load flanges is placed under the epitaxy enclosure (2) with which it communicates via a valve (4). The axis (5) of the cracker (6) is inclined by approximately 40° in relation to the vertical and the principal axis (7) of the tank (1), perpendicular to the axis (5) of the cracker, is inclined by approximately 40° in relation to the horizontal.

Such equipment according to the state of the art is compact and relatively easy to design for one of ordinary skill in the art. Nevertheless, it has various drawbacks.

First, maintenance of such equipment is difficult. The tank, of notably heavy weight, is delicate to handle because it is located under the enclosure and has to be removed so that it can be subjected to displacement at an angle offset from vertical.

Moreover, the positioning of the tank limits the acceptable volume and, thus, causes frequent reloadings and limits handlings upon readmission of air to the system, resulting in prolonged immobilization. This reloading is implemented via the assembly of flanges (3) in a zone of lower temperature opposite the vapor outlet. This results in a risk of rapid blockage of the flanges. The flange assembly (3) is positioned at the opposite end of the valve (4), which is superheated to prevent blockage.

### SUMMARY OF THE INVENTION

This invention relates to a tank for producing arsenic vapor including a crucible located inside an exterior enclosure which isolates the crucible from the ambient atmosphere such that a space exists between the crucible and the exterior enclosure, the space being subjected to a pressure lower than atmospheric pressure, the crucible having an outlet duct and an input flange located at or adjacent a superheated portion of the crucible.

This invention also relates to an epitaxy installation including an epitaxy enclosure communicating via a valve with the tank for the production of arsenic vapor, wherein the epitaxy enclosure and the tank are decouplably connected by a thermostated duct.

### BRIEF DESCRIPTION OF THE DRAWINGS

The invention will be better understood by reading the description below with reference to the attached drawings relative to a nonlimitative example of implementation in which:

FIG. 1 is a schematic view of epitaxy equipment according to the prior art;

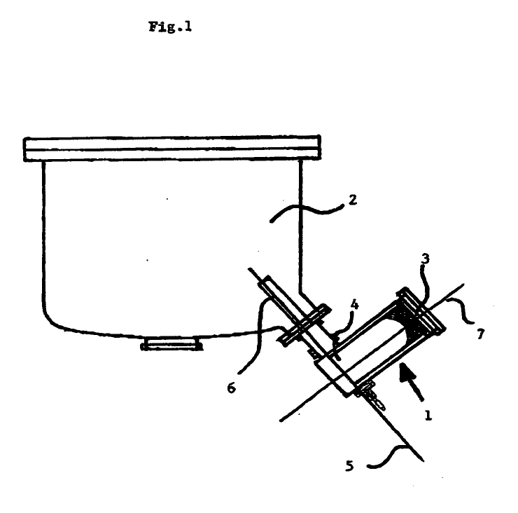

FIG. 2 is a partial schematic view of the epitaxy installation according to aspects of the invention; and

FIG. 3 is a schematic view of a variant of implementation of the invention.

### DETAILED DESCRIPTION

It will be appreciated that the following description is intended to refer to specific embodiments of the invention selected for illustration in the drawings and is not intended to define or limit the invention, other than in the appended claims.

In its broadest sense the invention relates to a tank for producing arsenic vapor (notably intended for molecular jet epitaxy equipment) constituted by a crucible located inside an exterior enclosure designed to isolate it from the ambient atmosphere. The space between the crucible and the exterior enclosure is subjected to a pressure lower than atmospheric pressure. The crucible is provided with an outlet duct and an input flange. The outlet duct and the input flange are located in the top part of the crucible.

The outlet duct and the flange are preferably located in an essentially isothermal zone. According to a preferred mode of implementation, the vapor outlet duct is located in the half of the crucible of elevated temperature in which is located the principal input flange. The crucible advantageously comprises means for the removable connection of the duct on the enclosure.

According to a particular mode of implementation, the enclosure has a condensation zone in the lower part of the tank, with the condensation zone communicating with the input flange.

The input flange of the crucible is advantageously located in a horizontal plane at the end of the top part of the tank.

The invention also pertains to an epitaxy installation comprising an epitaxy enclosure communicating via a valve with a tank, characterized in that the epitaxy enclosure and the tank can be decoupled. The tank is advantageously connected to the enclosure via the intermediary of a duct whose temperature is higher than that of the crucible. According to a preferred variant, it has a positive temperature gradient. According to a preferred variant, the coupling axis between the enclosure and the tank is horizontal. According to another variant, the duct is connected to the enclosure via a rotating connector. The generatrix axis of the tank is preferably essentially vertical.

According to an advantageous variant, the segment of the vapor outlet tube in the epitaxy enclosure is essentially perpendicular to the axis of the connection duct between the enclosure and the tank.

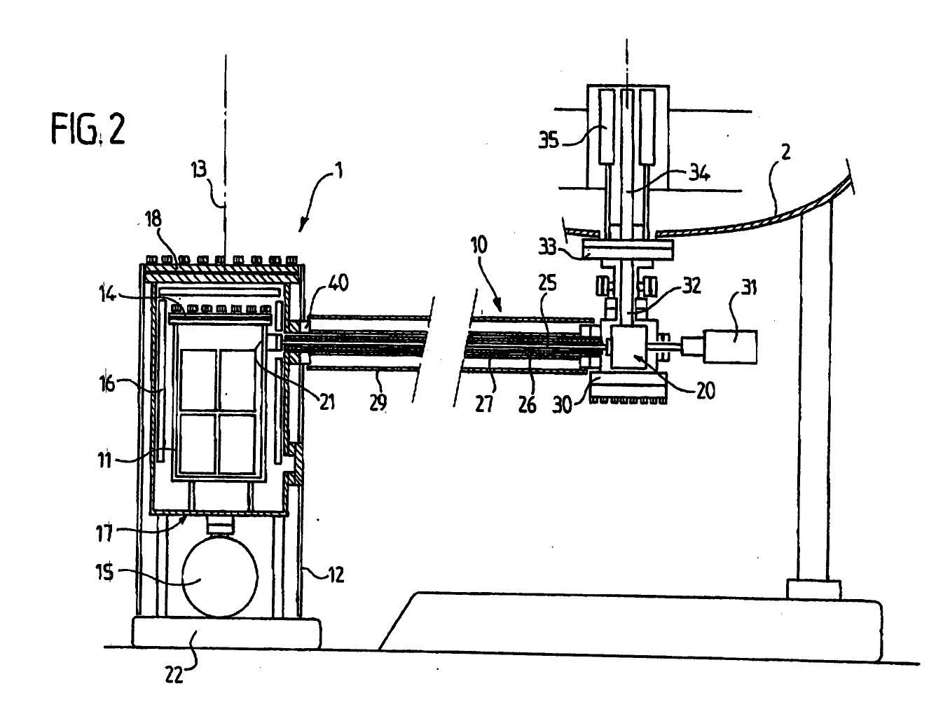

Turning now to the drawings, FIG. 2 represents a partial schematic view of an installation according to aspects of the invention. It comprises a tank (1) and an evaporation enclosure (2). In contrast to the prior art, the tank (1) is separated from the enclosure (2). It is positioned substantially vertically and connected to the enclosure by a thermostated duct (10).

The tank (1) is constituted of a crucible (11) placed in an enclosure under vacuum (12). The body of the tank has a vertical principal axis (13). It is formed by a tubular element with an interior section of about 350 mm and a height of about 1000 mm. It can be filled by an input flange (14) placed in a horizontal plane. This flange blocks the front end of the crucible (11) in a watertight manner. This crucible is surrounded by heating resistances (16) to provide a temperature on the order of about 500° C. The crucible (11) can contain about a hundred kilograms of arsenics. It can be reloaded without having to discharge the tank as is the case in the prior art.

The enclosure (12) is in contact with the epitaxy chamber and is under high vacuum to prevent penetration of air into the enclosure. This enclosure (12) is cooled to cause condensation of arsenic vapors on the walls. It has a cold point in its bottom part (17) to cause condensation close to an orifice communicating with a holding tank (15). The enclosure (12) has a temperature gradient wherein the temperature decreases toward the lower part. The enclosure (12) is also closed by a flange (18) which is closed in a watertight manner during use.

The connection between the tank (1) and the enclosure (2) is provided by a thermostated duct (10) connecting the crucible (11) at the one end to the valve (20) at the other end.

At the tank side, the duct (10) is connected to an opening (21) located close to the flange (14). The flange (14) and the opening on which is connected the duct (10) are located in the same part of the crucible in the top part of the tank characterized by the maximum temperature. The two openings—the arsenic feed opening and the arsenic vapor feed opening—are both positioned in a vaporization zone to avoid blockage by condensed arsenic.

The connection between the duct (10) and the tank (1) is implemented via a demountable junction enabling separation of the tank from the enclosure, notably for maintenance operations. The tank can be supported by a mobile frame (22) making it possible to move aside the epitaxy enclosure (2) and to remove the crucible (11) vertically via the front end of the enclosure (12) after disassembly and removal of the flange (18).

The duct (10) is constituted of an assembly of coaxial tubes. The bottom/inner tube (25) is designed to transmit the arsenic vapor produced by the tank (1). It is surrounded by a second tube (26) communicating with the enclosure (12) intended for the isolation of the atmosphere as well as the crucible (11) and the epitaxy enclosure (2). A heating element (27) provides for the maintenance of temperature with a positive temperature gradient such that the temperature passes from a temperature on the order of about 500° at the crucible outlet up to a temperature on the order of about 700° at the level of the valve (20). An exterior tube (29) optionally ensures thermal insulation.

The length of the duct corresponds essentially to the radius of the epitaxy enclosure and more precisely is determined in relation to the dimensions of the epitaxy enclosure and the tank (1). As an example, it has a length on the order of about 1500 mm. It extends horizontally between the input orifice of the valve (20) and the connecting flange of the tank (1). The connecting flange (40) is demountable to allow disassembly of the installation and removal of the tank by simple handling procedures.

This duct (10) is connected to the opposite end of the tank (1) from the valve. This valve is enclosed in a watertight envelope (30) communicating with the tube (26). The valve (20) is controlled manually or via a motor (31).

The valve outlet is formed by a duct (32) connecting to the epitaxy enclosure (2) via a coupling flange (33). This duct (32) opens into the epitaxy substrate. Its length can be determined to ensure diffusion very close to the substrate whereas, in the prior art, its length was limited by the fact that the removal of the tank could not be performed without removing this duct from the epitaxy enclosure.

This flange (33) provides communication with the duct (34) delivering the arsenic vapor. It is surrounded by a heating element (35) ensuring elevation of the temperature up to the cracking temperature when it is desired to diffuse AS₂ and not AS₄.

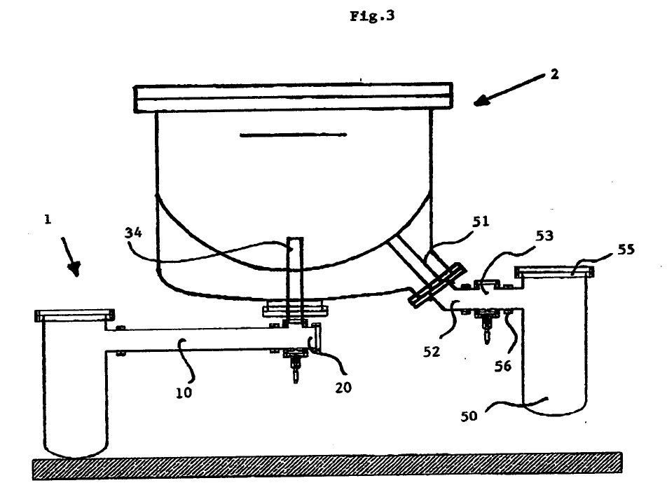

FIG. 3 represents in a single view two alternative installations of an arsenic evaporation device on an enclosure. The device can be installed on a vertical connector (left part of the figure) or on a connector inclined by 40 degrees (right part of the figure).

The device can be installed on a vertical connector (left part of the figure) or on connectors inclined by about 40-45° which comprise the epitaxy enclosure. Such inclined connectors are generally designed for the installation of ovens intended for the evaporation of elements such as gallium, indium or aluminum.

1. A tank for producing arsenic vapor comprising a crucible located inside an exterior enclosure which isolates the crucible from the ambient atmosphere such that a space exists between the crucible and the exterior enclosure, the space being subjected to a pressure lower than atmospheric pressure, the crucible having an outlet duct and an input flange located at or adjacent a superheated portion of the crucible.

2. The tank according to claim 1, wherein the outlet duct and the flange are located in an essentially isothermal zone of the crucible.

3. The tank according to claim 1, wherein the vapor outlet duct is located in a half of the crucible of elevated temperature in which is located the input flange.

4. The tank according to claim 1, wherein the crucible comprises means for removable connection for maintenance of the duct on the enclosure.

5. The tank according to claim 1, wherein the enclosure has a condensation zone in the lower part of the tank and the condensation zone communicates with an input flange.

6. The tank according to claim 1, wherein the input flange is located in a horizontal plane at the end portion of a top part of the tank.

7. An epitaxy installation comprising an epitaxy enclosure communicating via a valve with the tank in accordance with claim 1, wherein the epitaxy enclosure and the tank are decouplably connected by a thermostated duct.

8. The epitaxy installation according to claim 7, wherein the tank is connected to the epitaxy enclosure via a duct having a positive temperature gradient.

9. The epitaxy installation according to claim 7, wherein a coupling axis between the enclosure and the tank is horizontal.

10. The epitaxy installation according to claim 7, wherein the duct is connected to the enclosure via a rotating connector.

11. The epitaxy installation according to claim 7, wherein a generatrix axis of the tank is essentially vertical.

12. The epitaxy installation according to claim 7, wherein a segment of a vapor outlet tube in the epitaxy enclosure is essentially perpendicular to an axis of the connection duct between the enclosure and the tank.

13. The epitaxy installation according to claim 7, wherein a segment of a vapor outlet tube in the epitaxy enclosure is inclined by about 40 to about 45° to permit connection with the inclined connection of the epitaxy enclosure.
